(19) United States
(12) Patent Application Publication
(10) Pub. No.: US 2009/0320034 A1
(43) Pub. Date: Dec. 24, 2009

(54) DATA PROCESSING APPARATUS

(76) Inventors: Takanobu Tsunoda, Kokubunji (JP); Hiroshi Tanaka, Tsukuba (JP)

Correspondence Address: MILES & STOCKBRIDGE PC, 1751 PINNACLE DRIVE, SUITE 500, MCLEAN, VA, 22102-3833, US

(21) Appl. No.: 12/280,005

(22) PCT Filed: Mar. 27, 2006
(86) PCT No.: PCT/JP2006/306089

§ 371 Date: Apr. 23, 2009

(51) Int. Cl. G06F 9/46; G06F 12/00

(52) U.S. Cl. 718/103; 711/109; 711/E12.001

(57) ABSTRACT

A data processing apparatus has a memory element array (330) having a plurality of entries each formed by a memory element of more than one bit having a data shift function and a data comparison function, and the memory element array is arranged so that data can be shifted between corresponding bit positions of adjacent entries. Further, the data processing apparatus has a priority-judging circuit (340) for identifying one of the entries according to predetermined priorities based on results of comparison between data input to the entries in common and contents held by the memory elements constituting the entries. Even when the data held by an entry located halfway is nullified, data shift between entries can avoid that the entry with nullified data remains halfway, and enables the entries to hold valid data in order with the data densely aligned. The time sequence when data are held can be made coincident with the alignment of entries readily. As the time sequence of the entries is ensured uniquely, a given data can be identified from CAM search results by factoring in the priorities following the time sequence.

### TECHNICAL FIELD

The present invention relates to a data processing apparatus, and particularly to materialization of a task-state-management method and a circuit which searches, at a high speed, for a task which can be made to start running in regard to a multitask-type data processing apparatus capable of executing more than one task at a time.

### BACKGROUND ART

In recent years, data processing apparatuses including a digital versatile disc (DVD) recorder, which incorporate functions of processing multimedia such as images and sound and functions of communicating by wire and wireless, have widely come into use generally. As for such apparatuses, their capabilities to handle more than one task such as a codec processing, radio protocol processing and user interface processing at a high speed in parallel and in real time are related directly to the apparatuses' usability and worth per se.

Multitask control in such apparatuses is generally materialized by running a predetermined software program on a data processing apparatus typified by a built-in processor which controls a device. The software program (hereinafter referred to as “task management program”) is typically a part of an operating system, and has the function of selecting a task to be run subsequently according to a predefined scheduling policy in response to a predetermined cause of switching such as an interrupt showing the timing of switching a task to run. For the multitask control, which creates a processing overhead in contrast to data processing from the beginning, it becomes necessary especially to ensure a real-time characteristic, like a built-in processor, i.e. a response time to an event input which makes a cause of initiating a certain task until start of running of the task. On this account, what is required is not only a simple enhancement of performance of a data processing apparatus but also a new implementation method of multitask control for efficiently running a task management program.

Examples of the literature containing the description about a process by a task management program which materializes multitask control include Patent Documents 1 and 2. In Patent Document 1 described is a technique which enables overtaking of execution of an instruction making use of thread number and priority assigned to each instruction in a reservation station (an instruction buffer) of a multithread processor supporting an out-of-order execution. Patent Document 2 describes that an access to a computing resource is controlled according to the priority of each stream in a processor which treats a multistream, and the priority is dynamically changeable through an off-chip input, a software program or a hardware module.

[Patent Document 1] JP-A-2004-295195

[Patent Document 2] JP-T-2002-532801

### DISCLOSURE OF THE INVENTION

Problems that the Invention is to Solve

The inventor hereof studied details of processing by a task management program for materializing multitask control, and found the following problems to be solved from the viewpoint of boosting the running efficiency.

As described above, what forms a core of functions of the task management program is a process of selecting, from among a group of tasks in the condition where they can be made to start running, one task as the one to be run subsequently. The selecting process is a search action including a series of the process of comparing conditions and the process of making a judgment on all the tasks based on a scheduling policy, and it can be executed in parallel essentially. On the contrary, an implementing method which executes this process on a typical microprocessor needs sequential executions of the search action on a group of tasks. Therefore, the method poses not only the problem that the increase in the number of the tasks lowers the processing speed, but also the problem that it becomes difficult to ensure the real-time characteristic based on the worst value of the processing time of the task management program. As to the priority control in running a task created and pooled, the inventor found the importance of ensuring the time sequence of task creations, taking into account the real-time characteristic of a task whose condition of running has been met.

It is an object of the invention to provide a data processing apparatus which can ensure the speedup of the processes of comparing conditions and making a judgment for selecting data, and the time sequence of data selected.

It is another object of the invention to provide a data processing apparatus which can materialize multitask control with a high efficiency and a high-level of real-time characteristic.

The above and other objects and novel features of the invention will be apparent from the descriptions herein and the accompanying drawings.

Of embodiments of the invention herein disclosed, the representative ones will be outlined briefly below.

[1] A data processing apparatus (100) associated with the invention has a memory element array (330) having a plurality of entries (333-0 to 333-255) each formed by a memory element of more than one bit (800-0 to 800-m) having a data shift function and a data comparison function; the memory element array is arranged so that data can be shifted between corresponding bit positions of adjacent entries. Further, the data processing apparatus has a priority-judging circuit (340) for identifying one of the plurality of entries according to predetermined priorities based on results of comparison between data input to the plurality of entries in common and contents held by the memory elements constituting the plurality of entries.

According to the above-described means, a content-addressable-memory function as CAM (Content Addressable Memory) has enables a parallel comparison because respective entries have a data shift function and a data comparison function in memory elements. Further, even when the data held by an entry located halfway is nullified, data shift between entries can avoid that the entry with nullified data remains halfway, and enables holding valid data in the entries in order while densely laying it out. Therefore, when newly added data is held by an unoccupied entry at the rearmost position in the shift direction, it can be readily materialized to uniquely ensure the time sequence when the data to be held are added according to the alignment of the entries thus arranged. Desired data can be identified from CAM search results by factoring in their priorities according to the time sequence. This is because it becomes easier to uniquely ensure the time sequence of entries.

In a specific form of the invention, the predetermined priorities are ordinal positions of the entries holding significant data depending on a time sequence when the data were held by the entries. Thus, the priority control in consideration of time sequence for the purpose of identification of entries can be materialized readily.

[2] A data processing apparatus (100) associated with the invention has a memory element array (300) having a plurality of entries (333-0 to 333-255) each formed by a memory element (800-0 to 800-m) of more than one bit having a data shift function and a data comparison function; the memory element array is arranged so that data can be shifted in a direction between corresponding bit positions of adjacent entries. Also, the data processing apparatus has a control circuit (310, 320, 350) which controls a time-based ordinal position of the entry involved in holding of new data toward a direction opposite to a direction of the entry arrayed at the time of data shift in response to an operation command to hold the new data in the entry, and shifts data of the entry upstream to the nullified entries in time sequence toward a downstream direction by the number of the nullified entries in response to an operation command to nullify data held by the entry. In addition, the data processing apparatus includes a priority-judging circuit (340) for identifying one of the plurality of entries according to predetermined priorities based on results of comparison between search data input to the plurality of entries in common and search-target data held by memory elements constituting the plurality of entries. In this case, the predetermined priorities are predetermined ordinal positions in the time sequence.

According to the above-described means, the content-addressable-memory function enables a parallel comparison because respective entries have a data shift function and a data comparison function in memory elements. Further, even when the data held by an entry located halfway is nullified, data shift between entries can avoid that the entry with nullified data remains halfway, and enables holding valid data in the entries in order while densely laying it out. Therefore, when newly added data is held by an unoccupied entry at the rearmost position in the shift direction, the time sequence when the data to be held are added can be ensured uniquely according to the alignment of the entries thus arranged. Desired data can be identified from CAM search results by factoring in their priorities according to the time sequence. This is because it becomes easier to uniquely ensure the time sequence of entries. Thus, the priority control in consideration of time sequence for the purpose of identification of entries can be readily performed at a high speed.

In another specific form of the invention, the data processing apparatus has an unoccupied-entry-position pointer (318-8) for pointing the position of the entry accommodating new data. The pointer may be incremented or decremented according to the action of adding an entry for holding data and the action of shifting data held by an entry.

In still another specific form of the invention, the data processing apparatus has a data table (360) having a plurality of table entries each formed by a memory element of more than one bit having a data shift function; the data table is arranged so that data can be shifted between corresponding bit positions of adjacent table entries in a direction, and the plurality of table entries are in a one-to-one correspondence with the plurality of entries of the memory element array. The entry of the data table is subjected to data shift in synchronization with data shift performed on the entry of the memory element array. The data table outputs data held by the table entry corresponding to the one entry identified by the priority-judging circuit. The data thus output is a result which can be gained by associative searching.

In still further another specific form of the invention, the data processing apparatus has an expansion-output interface (380) capable of outputting a result of comparison with search-target data in the memory element array, and an expansion-input interface (370) capable of accepting, as an input, a result of comparison in a preceding stage, a logical product of the preceding-stage comparison result by the comparison result in the memory element array being produced. Thus, expansion that the scale of associative memory can be enlarged by aligning an array of memory elements in parallel is enabled.

[3] A data processing apparatus (100) associated with the invention has a processor unit (200) capable of running a multitask control program, a plurality of operation units (400-1 to 400-n) each assigned with a task to be run by the multitask control program, and a task-management unit (300) which performs a process of selecting a task to be run by each operation unit. The task-management unit has a memory element array (330), a control circuit (310, 320, 350), and a priority-judging circuit (340). The memory element array has a plurality of entries each formed by a memory element of more than one bit having a data shift function and a data comparison function, the memory element array being arranged so that data can be shifted in a direction between corresponding bit positions of adjacent entries. The control circuit controls a time-based ordinal position of the entry involved in holding of new task-management information toward a direction opposite to a direction of the entry arrayed at the time of data shift, in response to an operation command to hold the new task-management information in the entry, and shifts data of the entry upstream to the nullified entries in time sequence toward a downstream direction by the number of the nullified entries in response to an operation command to nullify data held by the entry from the processor unit. The priority-judging circuit identifies one of the plurality of entries according to predetermined priorities based on results of comparison between search data input to the plurality of entries in common and search-target data held by memory elements constituting the plurality of entries. The predetermined priorities are predetermined ordinal positions in the time sequence. The data processing apparatus may be formed on e.g. a semiconductor substrate.

According to the above-described means, the content-addressable-memory function enables a parallel comparison of task management information because respective entries have a data shift function and a data comparison function in memory elements. In addition, even when the task management information of an entry located halfway is nullified (when running of the corresponding task is completed), data shift between entries can avoid that the entry with nullified task management information remains halfway, and enables holding valid task management information in the entries in order while densely laying it out. Therefore, when newly added task management information is held by an unoccupied entry at the rearmost position in the shift direction, the time sequence when the task management information is added can be ensured uniquely according to the alignment of the entries thus arranged. Desired data can be identified from CAM search results by factoring in their priorities according to the time sequence. This is because it becomes easier to uniquely ensure the time sequence of entries. Thus, the priority control in consideration of time sequence can be readily performed at a high speed.

In a specific form of the invention, the task-management unit outputs a task ID contained in task management information held by the entry identified by the priority-judging circuit to the processor unit. The processor unit has the operation unit, which is not in active use, handle the task specified by the task ID.

In a further specific form of the invention, the task-management unit has a data table having a plurality of table entries each formed by a memory element of more than one bit having a data shift function; the data table is arranged so that data can be shifted between corresponding bit positions of adjacent table entries in a direction, and the plurality of table entries are in a one-to-one correspondence with the plurality of entries of the memory element array. The entry of the data table is subjected to data shift in synchronization with data shift performed on the entry of the memory element array. The data table outputs the task ID from the table entry corresponding to the one entry identified by the priority-judging circuit.

### EFFECTS OF THE INVENTION

Effects achieved by the representative ones of embodiments of the invention herein disclosed will be described below briefly.

That is, a data processing apparatus associated with the invention can ensure the speedup of processes of comparing conditions and making a judgment for selecting data, and the time sequence of data selected, and can materialize e.g. multitask control with a high efficiency and a high-level of real-time characteristic.

### BRIEF DESCRIPTION OF THE DRAWINGS

FIG. 1 is a block diagram generally showing an example of a data processing apparatus according to the invention.

FIG. 2 is a diagram of a format showing an example of a task pool for multitask control.

FIG. 3 is a block diagram showing an example of a task-management processor.

FIG. 4 is a block diagram showing an example of a main processor interface.

FIG. 5 is a block diagram showing an example of a task-state-management array.

FIG. 6 is a block diagram showing an example of a task-state-management entry.

FIG. 7 is a block diagram showing a first example of a task-state-management cell.

FIG. 8 is a block diagram showing a second example of the task-state-management cell.

FIG. 9 is a diagram of waveforms at terminals φSE1 and φSE2 of FIG. 8.

FIG. 10 is a flowchart showing the first half of a task control flow associated with the main processor.

FIG. 11 is a flowchart showing the latter half of the task control flow associated with the main processor.

FIG. 12 is a flowchart showing a concrete example of the process of array alignment by means of shift between entries shown in FIG. 11.

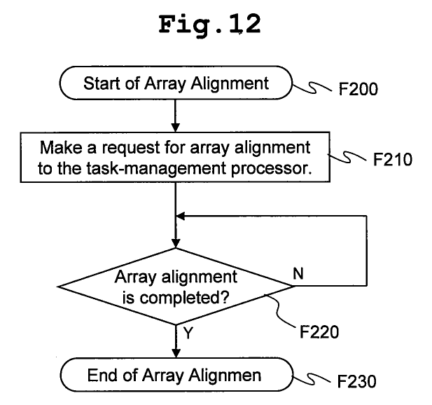

FIG. 13 is a flowchart showing a concrete example of the process of searching for a subsequent task shown in FIG. 11.

FIG. 14 is a flowchart showing the flow of array alignment control associated with the task-management processor.

FIG. 15 is a flowchart showing a concrete example of an array-update process shown by FIG. 14.

### EXPLANATION OF REFERENCE NUMERALS

100: DATA PROCESSING APPARATUS
200: MAIN PROCESSOR (PROCESSOR UNIT)
300: TASK-MANAGEMENT PROCESSOR (TASK-MANAGEMENT UNIT)
400-1 to 400-n: OPERATION UNIT
500: INTERNAL BUS
510: OPERATION-UNIT-CONTROL BUS
600: PERIPHERAL MODULE
700: MAIN MEMORY INTERFACE
710: MAIN MEMORY
TID-0 to TID-k: TASK ID
ST-0 to ST-k: TASK STATE
PRI-0 to PRI-k: RUN PRIORITY
FLG-0 to FLG-k: RUN-FLAG
310: MAIN PROCESSOR INTERFACE
320: ARRAY-ACCESS-ARBITRATION UNIT
330: TASK-STATE-MANAGEMENT ARRAY
340: PRIORITY-JUDGING UNIT (PRIORITY-JUDGING CIRCUIT)
350: ARRAY UPDATE CONTROL UNIT
360: TASK ID TABLE (DATA TABLE)
370, 380: TASK-MANAGEMENT-PROCESSOR-EXPANSION INTERFACE
318: CONTROL REGISTER
318-8: UNOCCUPIED-ENTRY-POINTER FIELD
330: TASK-STATE-MANAGEMENT ARRAY
332: ENTRY ACCESS CONTROL UNIT
333-0 to 333-255: TASK-STATE-MANAGEMENT ENTRY
800-0 to 800-m: TASK-STATE-MANAGEMENT CELL

### BEST MODE FOR CARRYING OUT THE INVENTION

A preferred embodiment of the data processing apparatus associated with the invention will be described below with reference to the accompanying drawings. The circuit elements cited below, which the data processing apparatus includes, are not particularly limited, however they are formed on a substrate of semiconductor such as monocrystalline silicon by the well-known semiconductor integrated circuit technology for a CMOS transistor, a bipolar transistor and the like.

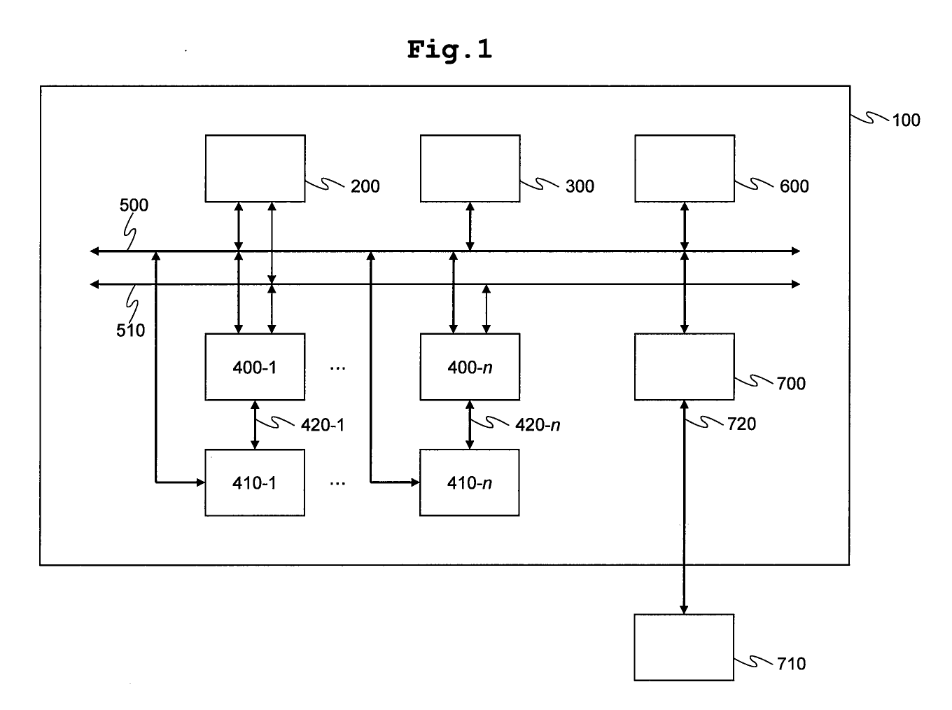

FIG. 1 shows an example of a data processing apparatus according to the invention. The data processing apparatus 100 includes: a main processor (processor unit) 200; a task-management processor (task-management unit) 300; n operation units 400-1 to 400-n; n local memories 410-1 to 410-n; n local memory buses 420-1 to 420-n; an internal bus 500; an operation-unit-control bus 510; a peripheral module 600; a main memory interface 700; a main memory 710; and a main memory bus 720.

The main processor 200 has a specific instruction set similar to that of a typical microprocessor, and controls the action of the data processing apparatus according to various control programs (not shown) including a multitask control program stored in the main memory 710.

The task-management processor 300, in concert with a multitask control program working on the main processor 200, holds the state of each task, and when switching between tasks, the processor executes the process of selecting a task to be run subsequently at a high speed and in a fixed length of time, thereby increasing the efficiency of multitask control.

On receipt of a predetermined request signal for starting a task running which shows that the multitask control program working on the main processor 200 has assigned the operation units 400-1 to 400-n to a task to run through the operation-unit-control bus 510, the operation units 400-1 to 400-n concerned execute the assigned task by a series of the actions of: reading operation data stored in the local memories 410-1 to 410-n through the local memory buses 420-1 to 420-n; executing the predetermined process; and again storing the result of the operation in the local memories 410-1 to 410-n. After completion of running of the task, the relevant operation units 400-1 to 400-n send a predetermined notice of completion of task execution to the main processor 200 through the operation-unit-control bus 510.

The internal bus 500 interconnects the main processor 200, the task-management processor 300, the operation units 400-1 to 400-n, the local memories 410-1 to 410-n, the peripheral module 600, and the main memory interface 700, and controls data transmission there between.

The peripheral module 600 has various functions including: a DMA transmission function of performing data transmission between the main memory 710 and the local memories 410-1 to 410-n; a timer function of offering a reference time for task switching; and control of an input-output device, which is not shown in the drawing.

The main memory interface 700 controls access to the main memory 710 through the main memory interface 720. Now, it is noted that the main memory 710 may be formed in the same or different chip of the data processing apparatus 100.

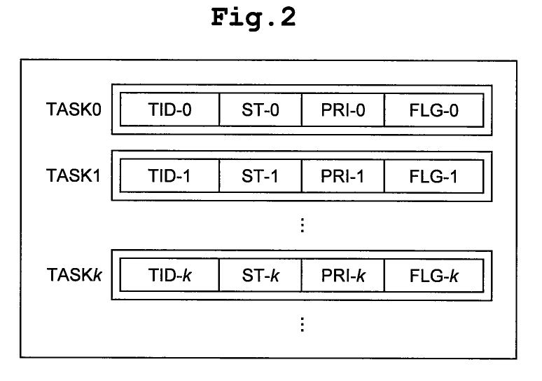

Now, the multitask control in the data processing apparatus 100 will be outlined below. FIG. 2 shows an example of a task pool for multitask control, which is used for managing the state of each task. The states of the tasks TASK0 to TASKk are represented by task management information. In FIG. 2, the task management information includes e.g. task IDs (TID-0 to TID-k), task states (ST-0 to ST-k), run priorities (PRI-0 to PRI-k), and run-flags (FLG-0 to FLG-k). In the data processing apparatus 100, the task management information is stored inside the task-management processor 300.

The task IDs are signs uniquely assigned to identify respective tasks. The task states are state signs each showing that a task concerned is in either of: (1) a state where the task is waiting for the time when conditions for allowing the task to be run are all fulfilled (Waiting) ; (2) a state where all the conditions for allowing the task to be run have been met, and the task is waiting for permission to start running (Ready); and (3) a state where the task is running, and waiting for completion thereof (Running). The run priorities are signs for showing the urgency of running the respective tasks. The run-flags show which of a group of conditions necessary to start to run a task concerned has been fulfilled; the requirements of the group include the completion of run of a task having a certain ID and the completion of initial data preparation.

The task management program for materializing multitask control works as described below.

(1) In the case of starting a task newly, the task is assigned with a task ID and a run priority, and added into the task pool, and in parallel, the task state for the task is initialized into “Waiting” and the run-flags are all cleared.

(2) In the case where an event requiring task switching occurs, e.g. when a running task has been completed, or when the running time of the running task has exceeded a predetermined time, the task is stopped and deleted from the task pool, or the task state is updated from “Running” into “Ready”. Further, in the case where the completion of the task concerned is specified as a condition of starting another task running, the run-flags are updated appropriately, and the task state of the task whose run-flags all show the fulfilled state is updated from “Waiting” into “Ready”.

(3) At the time of switching a task, a task to be run subsequently is selected from among a group of tasks whose task states are “Ready” based on a predetermined scheduling policy; the task thus selected is e.g. the one which has the highest run priority and has been added into the task pool at the earliest time. In addition, the selected task is notified of permission to start running, and the task state is updated from “Ready” into “Running”.

With regard to a data processing apparatus required to have real-time characteristic, which is the central feature of the invention, it is the most important in the above (3) that the time needed for switching a task is sufficiently small and its worst value is ensured. In the case where the task pool is stored in an off-chip memory 710 or an on-chip memory contained in the peripheral circuit 600, but not shown in the drawing, and the whole task management control is implemented by a software program of the main processor 200, it becomes difficult to secure the real-time characteristic because it must access to a main memory which requires a large access time or the like and increases search time according to the number of tasks held in the task pool in searching the task pool, which is necessary to select a task. In contrast, the task-management processor 300 is a circuit which performs a parallel search action independently of the number of tasks, and in addition, ensures the time sequence thereby to enable efficient multitask control. The detail of task management control by the task-management processor 300 will be described below.

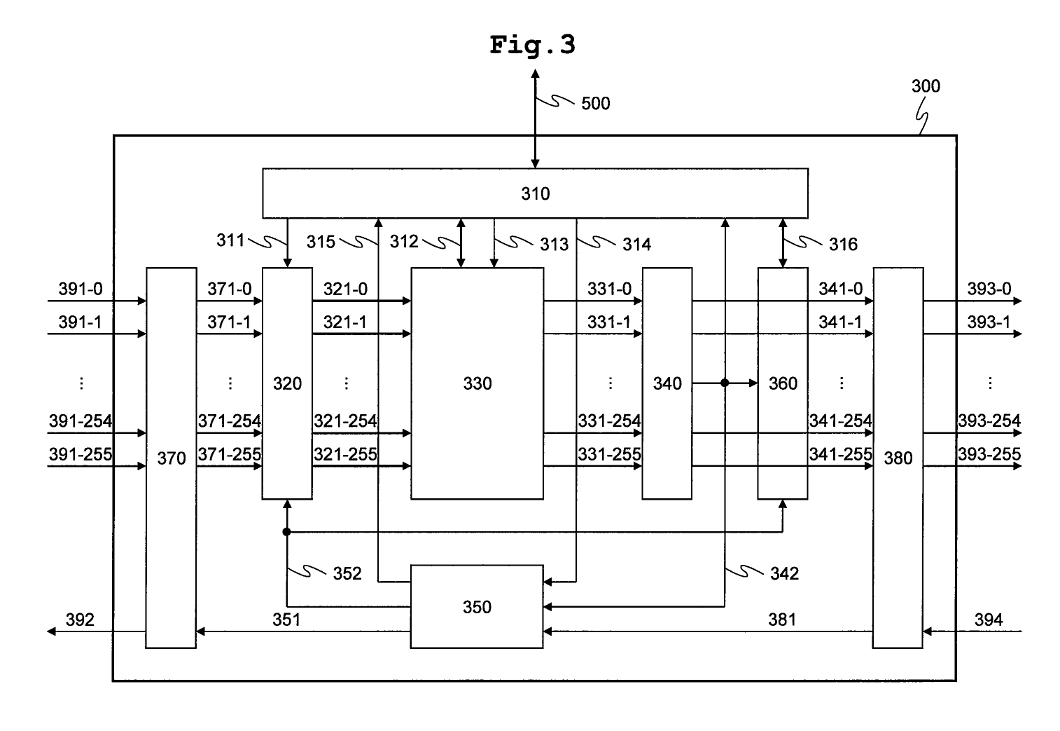

FIG. 3 shows an example of the task-management processor 300. The task-management processor 300 includes: a main processor interface 310; an array-access-arbitration unit 320; a task-state-management array 330; a priority-judging unit (a priority-judging circuit) 340; an array update control unit 350; a task ID table (a data table) 360; and task-management-processor-expansion interfaces 370 and 380. The main processor interface 310, array-access-arbitration unit 320, and array update control unit 350 constitute a control circuit which responds to an action command from the main processor 200 to perform task management control using the memory element array. 311 denotes an array-access-arbitration-unit-control bus, 312 denotes a task-state-management-array-control bus, and 313 denotes a task-state-management-array search signals. 314 and 315 denote an array-update-control-unit control signals. 316 denotes a task-ID-table-control bus. 321-0 to 321-255 denote task-state-management-entry control signals. 331-0 to 331-255 denote task-state-management-entry-comparison signals. 341-0 to 341-255, 371-0 to 371-255, 391-0 to 391-255 and 393-0 to 393-255 denote task-state-management-entry-state signals, and 342 denotes a priority-judgment signal. 351, 381, 392 and 394 denote external array update control signals. 352 denotes an array update control signal 352.

The main processor interface 310 contains a group of control registers for defining actions of the task-management processor 300, and controls a control register access between the internal bus 500 and the units inside the task-management processor.

The task-state-management array 330 has 256 task-state-management entries, stores at least the task state and run priority of each task through the task-state-management-array-control bus 312 as a task pool composed of a hardware module, and outputs the task-state-management-entry-comparison signals 331-0 to 331-255 according to the content of the task-state-management-array search signal 313. Each task-state-management entry is composed of a memory element of more than one bit having a data shift function and a data comparison function, and has a function as a CAM. While the detail is to be described later, the task-state-management entries are arranged so that data can be shifted between corresponding bit positions of the adjacent task-state-management entries.

The array-access-arbitration unit 320 adds the task-state-management-entry-state signals 371-0 to 371-255, which are produced by the task-management-processor-expansion interface 370 based on the task-state-management-entry-state signals 391-0 to 391-255 output by a task-management processor (not shown) neighboring on the upstream side (on the left of the drawing), to an access control signal resulting from arbitration a signal coming from the main processor interface 310 via the array-access-arbitration-unit-control bus 311 and an array update control signal 352 from the array update control unit 350, thereby to output the task-state-management-entry control signals 321-0 to 321-255. In short, the array-access-arbitration unit 320 performs the control of read and write accesses to each task-state-management entry of the task-state-management array 330. The direction is given by the main processor interface 310, the task-management-processor-expansion interface 370 and the array update control unit 350. Especially, when responding to a direction for entry update from the array update control unit 350, the array-access-arbitration unit 320 controls read and write actions for the shift action between task-state-management entries.

From a task-state-management-entry-comparison signal showing a matching state, out of the task-state-management-entry-comparison signals 331-0 to 331-255 as described above, the priority-judging unit 340 selects, one entry according to a specified predetermined priority, e.g. by setting the entry 0 (333-0) to the highest priority, and the entry 255 (333-255) to the lowest priority, and outputs a priority-judgment signal 342 for identifying the selected entry. Further, the priority-judging unit 340 outputs the task-state-management-entry-state signals 341-0 to 341-255, from which the task-management-processor-expansion interface 380 produces the task-state-management-entry-state signals 393-0 to 393-255 and outputs them to a task-management processor (not shown) neighboring on the downstream side (on the right of the drawing). Thus, the task-management-processor-expansion interface 380 can output a result of judgment by the priority-judging unit 340 to the task-management processor (not shown) neighboring on the downstream (on the right of the drawing).

When the external array update control signal 381, which the task-management-processor-expansion interface 380 has produced from the external array update control signal 394, contains a request for update of the array, or when the array-update-control-unit control signal 314, in which the setting of the control registers in the main processor interface 310 is incorporated, contains the request for update of the array, the array update control unit 350 makes a request for the shift processing of a task-state-management entry and the corresponding task ID based on the content of the request for update of the array to the array-access-arbitration unit 320 and the task ID table 360 though the array update control signal 352. Further, the array update control unit 350 outputs the external array update control signal 351, in which the detail of the requested shift processing is incorporated, as the external array update control signal 392 through the task-management-processor-expansion interface 370, and in addition, notifies the main processor interface 310 by the array-update-control-unit control signal 315 of whether the shift processing has been executed or not.

The task ID table 360 stores a task ID corresponding to each task stored in the task-state-management array 330 as a task pool composed of a hardware module according to a signal through the task-ID-table-control bus 316, and outputs the task ID corresponding to the priority-judgment signal 342 output by the priority-judging unit 340 to the task-ID-table-control bus 316. When shift processing between entries is requested by the array update control signal 352, in the task ID table 360, the shift processing of the corresponding task ID is performed. Specifically, omitted from the graphical representation, however, the task ID table 360 has a plurality of table entries, which are arranged so that a memory element of more than one bit having a data shift function forms one table entry, and one-way data shift can be performed between corresponding bit positions of adjacent table entries. The table entries of the task ID table differ from those of the task-state-management array 330 in their bit number and having no comparison function. The table entries of the task ID table may have CAM function. Such case is allowable as long as the CAM function is not used. In the task ID table 360, the table entries are in one-to-one correspondence with the entries of the memory element array. The entries (data table entries) of the task ID table 360 undergo the data shift action in synchronization with the data shift action on the entries of the memory element array. The task ID table 360 outputs the task ID held by a table entry corresponding to one entry identified by the priority-judging unit 340.

The task-management-processor-expansion interfaces 370 and 380 perform control so as to transmit the task-state-management-entry-state signals 341-0 to 341-255 produced based on the comparison signals 331-0 to 331-225 output by the task-state-management entries of the task-state-management array to the same task-state-management entries of the neighboring task-management processor, or not to do so if required. Also, the task-management-processor-expansion interfaces 370 and 380 perform transmission of the external array update control signals 392 and 394 for controlling shift actions of the task-state-management entries between the neighboring task-management processors, and the array update control unit 350 performs control so that the contents of the task-state-management entries are not inconsistent between the neighboring task-management processors. Thus, when two or more task-management processors 300 are connected mutually, identical task-state-management entries of the task-state-management arrays can be logically joined and made to work as a unit entry, and therefore it becomes possible to scalably change the size of the entries. It is needless to say that when the function of connecting the task-management processors is unnecessary, the hardware scale of the task-management processor 300 can be made smaller by eliminating all or part of the task-management-processor-expansion interfaces 370 and 380, the task-state-management-entry-state signals 341-0 to 341-255, 371-0 to 371-255, 391-0 to 391-255 and 393-0 to 393-255, and the external array update control signals 351, 381, 392 and 394. When the task-state-management-entry-state signals 391-0 to 391-255 from the preceding stage imply disparity in the preceding stage as a result of comparison, they are evaluated as signals which restrict the validity of result of comparison of a corresponding entry in the task-state-management array 330.

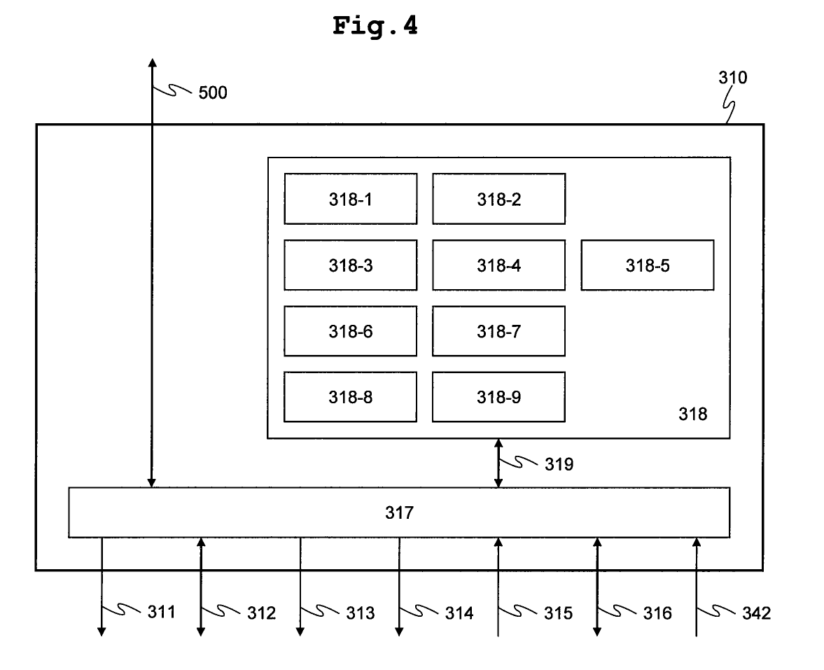

FIG. 4 shows a concrete example of the main processor interface 310. The main processor interface 310 includes: a control register access control unit 317; a control register 318; and a control register access bus 319.

The control register access control unit 317 responds to a request for access through the internal bus 500, and controls: access to the control register 318 through the control register access bus 319; access to the task-state-management array 330 through the array-access-arbitration-unit-control bus 311 and the task-state-management-array-control bus 312; and access to the task ID table 360 through the task-ID-table-control bus 316, respectively. In addition, the control register access control unit 317 outputs the task-state-management-array search signal 313 and the array-update-control-unit control signal 314 according to the content of the control register 318, and updates the content of the control register 318 according to the contents of the array-update-control-unit control signal 315 and the priority-judgment signal 342.

The control register 318 includes: a search-request field 318-1 for showing the presence or absence of a search request to the task-state-management array 330; a search-key field 318-2 for storing a string of signs including a predetermined task state and a run priority, which are used as search keys for the task-state-management array 330 or a predetermined sign for searching for an unoccupied entry position in the task-state-management array 330; a search-result-validity field 318-3 for showing the validity of a search result; a task-ID field 318-4 for storing a corresponding task ID and an entry position in the task-state-management array 330 respectively when the search result is valid; an entry-position field 318-5; a task-state-management-array-update-request field 318-6 for showing the presence or absence of a request for shift processing of a task-state-management entry by the array update control unit 350; a task-state-management-array-update-mode field 318-7 for specifying the detail of the shift processing, e.g. either “ONESHOT” (to conduct one shift for each request) or “FULL” (to conduct the maximum number (the number of entries minus 1) of shifts for each request); an unoccupied-entry-pointer field (unoccupied-entry-position pointer) 318-8 for showing the position of an entry in the task-state-management array, to which a new task is to be added; and a working-status field 318-9 for showing the working status of the task-management processor 300, e.g. “busy” or “non-busy”

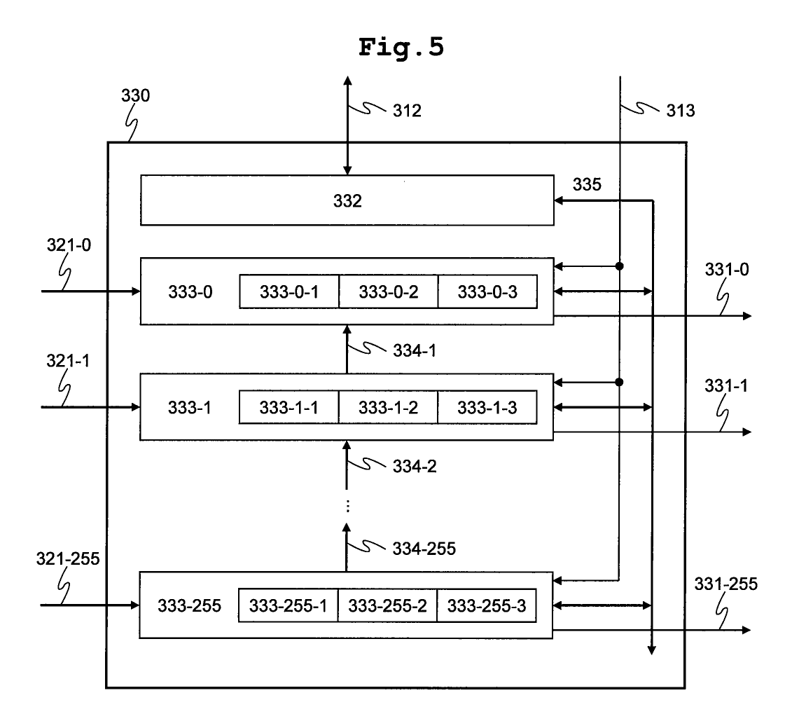

FIG. 5 shows a concrete example of the task-state-management array. The task-state-management array 330 includes: an entry access control unit 332; 256 task-state-management entries 333-0 to 333-255; inter-entry-shift-data buses 334-1 to 334-255; and an entry-access bus 335. Further, the task-state-management entries each include: an enable field 333-0-1 to 333-255-1 for showing whether the content of the entry is valid; a task-state field 333-0-2 to 333-255-2 for showing the task state of task information stored in the entry; and a run-priority field 333-0-3 to 333-255-3 for showing the run priority of task information stored in the entry.

The entry access control unit 332 relays access to the task-state-management entries 333-0 to 333-255 through the task-state-management-array-control bus 312. The entry access control unit 332 performs an action on the task-state-management entries 333-0 to 333-255 having entry numbers 0 to 255 respectively, according to a request for read, write, shift or other action specified by the task-state-management-entry control signals 321-0 to 321-255; the action is e.g. outputting the content of the entry concerned to the entry-access bus 335, or writing predetermined data on the entry-access bus 335 or the content of a neighboring entry having a larger entry number into the entry concerned (downstream one-step shift). Also, according to a search request and a search key on the task-state-management-array search signal 313, the entry access control unit 332 checks the matching between the content of the entry concerned and the search key, and outputs a result of the check for the task-state-management-entry-comparison signal 331-0 to 331-255.

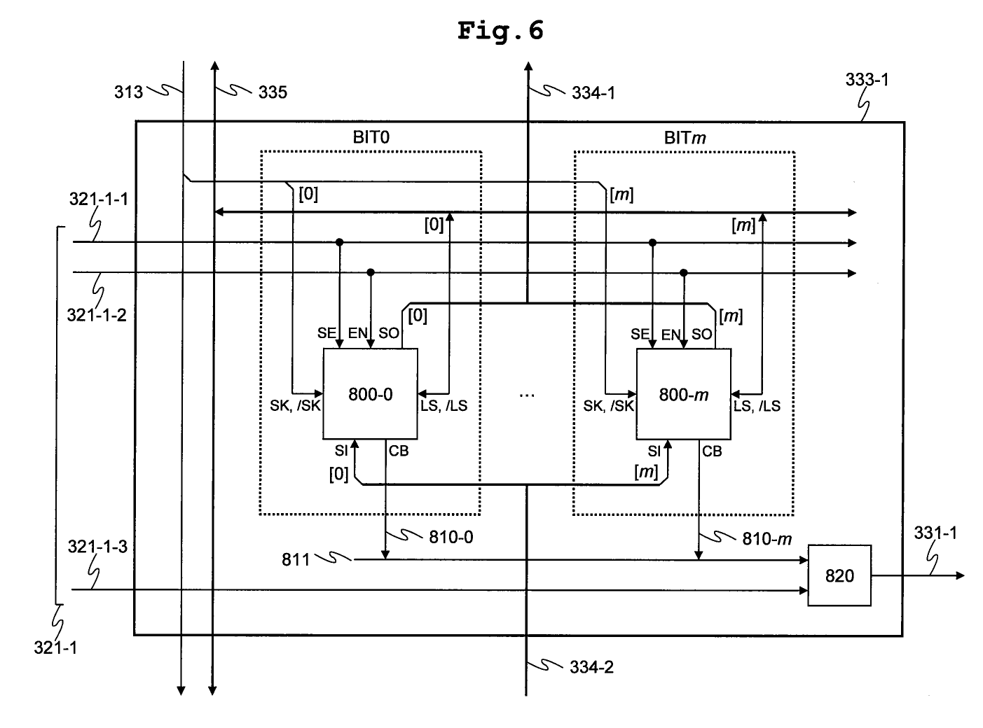

FIG. 6 shows an example of the task-state-management entries. The task-state-management entry 333-1 includes: (m+1) task-state-management cells 800-0 to 800-m; task-state-management-cell-comparison signals 810-0 to 810-m; a task-state-management-cell-comparison bus 811; and a task-state-management-entry comparison unit 820, provided that the sum of the bit widths of the enable field 333-1-1, task-state field 333-1-2 and run-priority field 333-1-3, which are shown in FIG. 5, is m+1. In addition, the task-state-management-entry control signal 321-1 is not particularly limited, however it includes: entry-shift enable 321-1-1; entry-access enable 321-1-2, and a neighboring-array-entry-match signal 321-1-3 produced from the task-state-management-entry-state signal 371-1 (see FIG. 3).

The task-state-management cells 800-0 to 800-m each serve as a memory circuit with one-bit shift and comparison functions, and has input and output terminals listed below.

(1) SE, which is a terminal for a shift enable input to the cell, represented by the positive logic, and to which entry-shift enable 321-1-1 is coupled.

(2) EN, which is a terminal for an access enable input to the cell through the task-state-management-array-control bus 312, represented by the positive logic, and to which entry-access enable 321-1-2 is coupled.

(3) SI, which is a terminal for a shift-data input to the cell from a lower-rank entry, and to which a signal corresponding to the bit concerned in the inter-entry-shift-data bus 334-2 is coupled.

(4) SO, which is a terminal for a shift-data output from the cell to a higher-rank entry, i.e. one-bit data held in the cell per se, and which is coupled to a signal corresponding to the bit concerned in the inter-entry-shift-data bus 334-1.

(5) LS and /LS, which are terminals for write data to the cell through the task-state-management-array-control bus 312 represented by the positive logic (in a write action) and for readout data from the cell represented by the negative logic (in a readout action), and to which signals corresponding to the bit concerned in a load-store-data field, contained in the entry-access bus 335 and its inversion are coupled.

(6) SK and /SK, which are terminals for search key inputs to the cell represented by the positive logic and negative logic respectively, to which signals corresponding to the bit concerned in a search-key field contained in the task-state-management-array search signal 313 and its inversion are coupled. The terminals are not particularly limited. However, a particular expression such as a combination of SK=1 and /SK=1 (comparison mask) may be used so that the result of comparison with a search key indicates matching at all times whatever the content of one-bit data is held in the cell.

(7) CB, which is a terminal for a comparison output from the cell, represented by the negative logic; the output shows a result of comparison of one-bit data held in the cell with an input to the terminal SK, and is coupled to, of the task-state-management-cell-comparison signals 810-0 to 810-m, a signal corresponding to the bit concerned.

The task-state-management-cell-comparison bus 811 is a bus arranged so that a logical AND operation in the negative logic expression by wired OR can be executed on the task-state-management-cell-comparison signals 810-0 to 810-m output by the (m+1) task-state-management cells 800-0 to 800-m. When a signal on the task-state-management-cell-comparison bus 811 and a neighboring-array-entry-match signal 321-1-3 show a matching state, the task-state-management-entry comparison unit 820 outputs a signal of an entry-matching state as the task-state-management-entry-comparison signal 331-1. The task-state-management-entry comparison unit 820 can be regarded as a logical AND circuit.

Incidentally, as to the task-state-management entries 333-2 to 333-254, the arrangement of FIG. 6 can be applied to the entries by associating the signs of FIG. 6 to them appropriately. With the task-state-management entries 333-0 and 333-255, the arrangement of FIG. 6 can be applied to them except that each shift-data output SO remains uncoupled and an appropriate fixed value (not shown) is entered into each shift-data input SI.

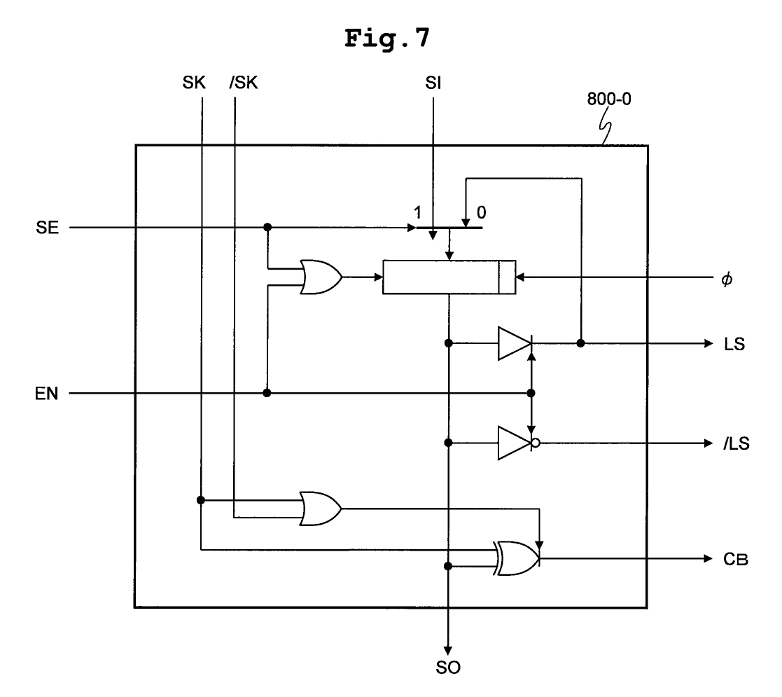

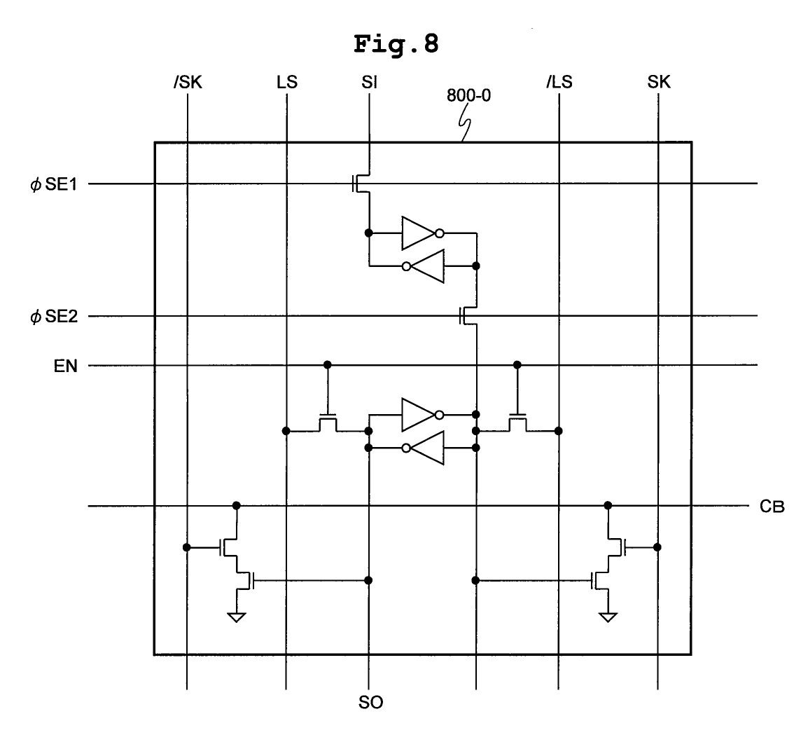

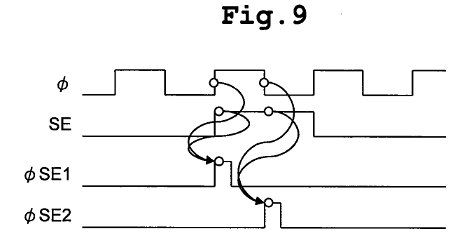

Now, the internal circuit configuration of the task-state-management cells will be described below. FIG. 7 shows a first example of the task-state-management cells, and FIG. 8 shows a second example of the task-state-management cells. Here, the input and output terminals are identical in functions with the corresponding input and output terminals in FIG. 6. However, to the terminal φ in FIG. 7 input is an operation clock signal of a data processing apparatus, which is not shown in FIGS. 1 to 6; to the terminals φSE1 and φSE2 of FIG. 8, signals showing the positions of rising and falling edges of the operation clock signal φ when SE=1 as shown in the example of FIG. 9 are input. In the first example of FIG. 7, a combination of SK=1 and /SK=0 or a combination of SK=0 and /SK=1 can be set as a search key input, and only a simple matching comparison can be made. On the other hand, in the second example of FIG. 8, in addition to the above combinations, a combination of SK=1 and /SK=1 can be set, and a comparison mask action that the result of comparison indicates matching at all times whatever the content of one-bit data is held in the cell can be executed.

Now, the points of using the task-management processor 300 described in detail with reference to FIGS. 3 to 9 through the multitask control program working on the main processor 200 uses in executing multitask control in the data processing apparatus 100 will be summarized below.

(1) In the task-management processor 300, at least a task ID, a task state and a run priority in the task pool are stored, and the details are set by the main processor 200. The task state is specified, not particularly limited thereto, by one of “Waiting”, “Ready” and “Running”, and the run priority is specified by one of 0 (highest) to 255 (lowest). As to the run priority, the same run priority may be set for two or more tasks.

(2) As for the 256 task-state-management entries 333-0 to 333-255 constituting the task-state-management array 330 and having the shift function, the order of using the entries is prescribed so that the entries are operated according to First-In-First-Out (FIFO), which can ensure the time sequence of tasks whose information is held in the entries. That is, when the task management information of one of the task-state-management entries 333-0 to 333-255 is nullified halfway, one-step data shift to the downstream direction in the task-state-management entries can avoid that the task-state-management entry with the invalid task management information remains halfway, and enables holding valid task management information in the task-state-management entries in order while densely laying it out. Therefore, newly added task management information is held by an unoccupied entry at the rearmost position in the shift direction so that the time sequence when the task management information are added can be uniquely ensured according to the alignment of the task-state-management entries thus aligned.

(3) As for the priorities (entry priorities) of the task-state-management entries 333-0 to 333-255, the entry 333-0 corresponding to the exit of FIFO in position, which is the oldest in the time sequence, is the highest in priority, and the entry 333-255 is the lowest. The entry priority differs from entry to entry, and is differentiated from the run priority. Duplication of these priorities never occurs among two or more entries.

(4) Causes of task switching are not particularly limited, however there are two such causes as described below. (4-a) Completion of a task. When the cause arises, a task-state-management entry in which the task ID, task state and run priority of a task concerned have been stored is nullified. (4-b) Suspension of a task owing to a predetermined cause of switching such as an interrupt. When the cause arises, the task state of a task concerned is updated from “Running” into “Ready”.

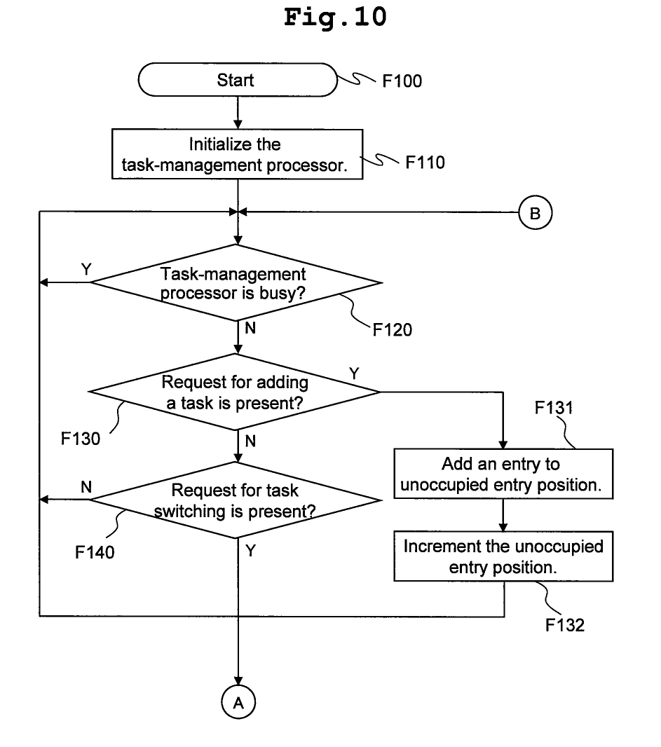

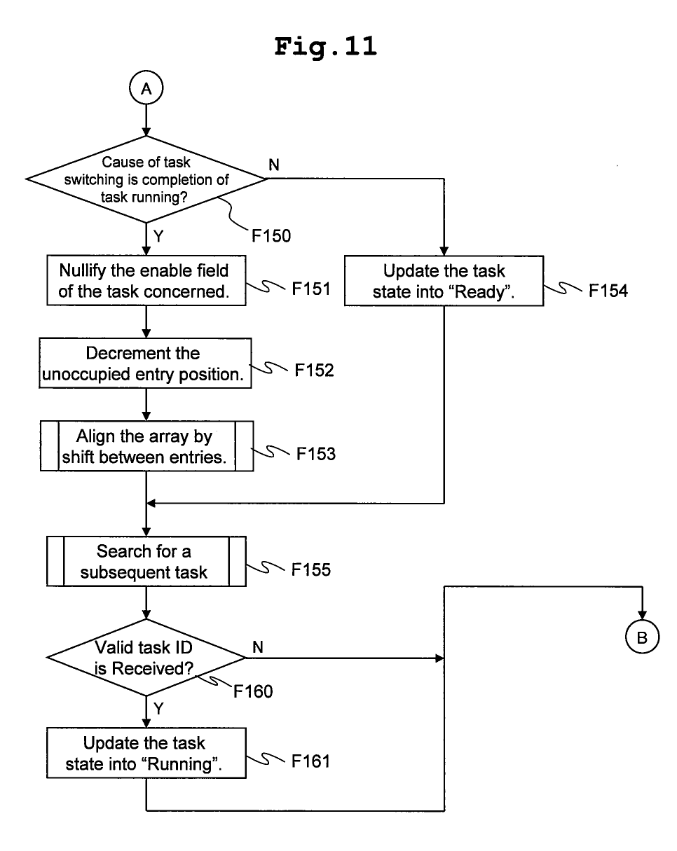

FIGS. 10 and 11 show a flow of task control by the task management program working on the main processor 200. First, in Step F110 the task-management processor 300 is initialized thereby to nullify all the task-state-management entries and write an initial value in the control register. However, a value of zero (0) representing the entry 0 (333-0) is written in the unoccupied-entry-pointer field 318-8.

When the initialization is completed, the task management program monitors the state of the task-management processor 300 (Step F120), and waits until the status of the task-management processor 300 is turned to a non-busy condition. When going into the non-busy condition, the task-management processor 300 performs necessary processes depending on whether a request for addition of a task and a request for task switching have been presented or not. On receipt of a request for addition of a task (Step F130), the task-management processor assigns a task ID and a run priority to the task concerned, and updates the task-state-management entry specified by the unoccupied-entry-pointer field 318-8 and the content of the corresponding entry in the task ID table (Step F131), and concurrently increments the content of the unoccupied-entry-pointer field 318-8 (Step F132).

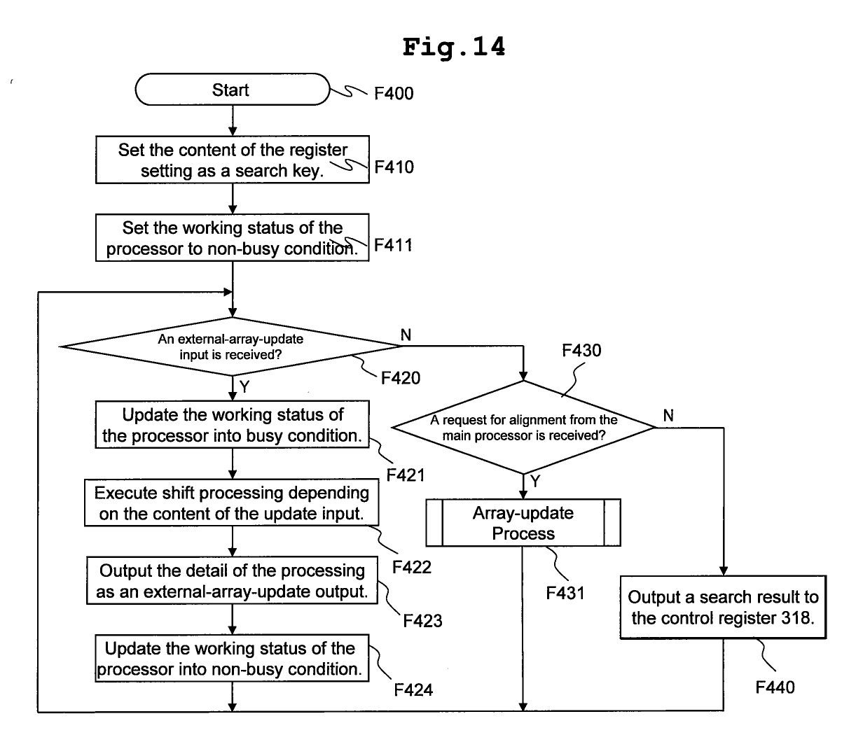

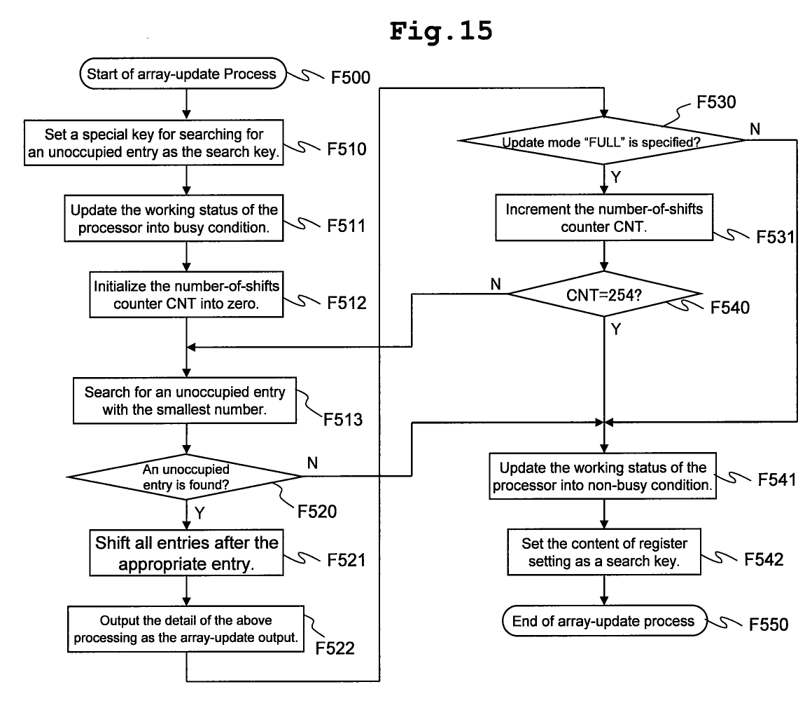

When the task-management processor receives a request for task switching (Step F140), the detail of processing depends on its cause (Step F150). First, when the request comes from completion of a task, the task-management processor nullifies the enable field of the task-state-management entry in which the information concerning the completed task is stored (Step F151), decrements the unoccupied-entry-pointer field 318-8 (Step F152), and executes an array-aligning process of eliminating a faulty alignment state inside FIFO resulting from the nullification (Step F153), in order. When the request concerned is not a request coming from the completion of a task but a request for suspending a predetermined task, the task state in the task information about the running task is updated from “Running” into “Ready” (Step F154). The entry update process (Step F154) includes waiting from (Step F210) a request for array alignment owing to write, on the control register, to the task-state-management-array-update-request field 318-6 and the task-state-management-array-update-mode field 318-7 to the completion of the array-aligning process (Step F220). The action of the task-management processor in response to the request for array alignment is to be described later with reference to FIGS. 14 and 15.

After completion of the task or its suspension process, a search for a task to be run subsequently is performed (Step F155). In the case where a task which can be run has been selected (Step F160), the task state of the task is updated from “Ready” into “Running” (Step F161), and then the task is notified of permission for running.

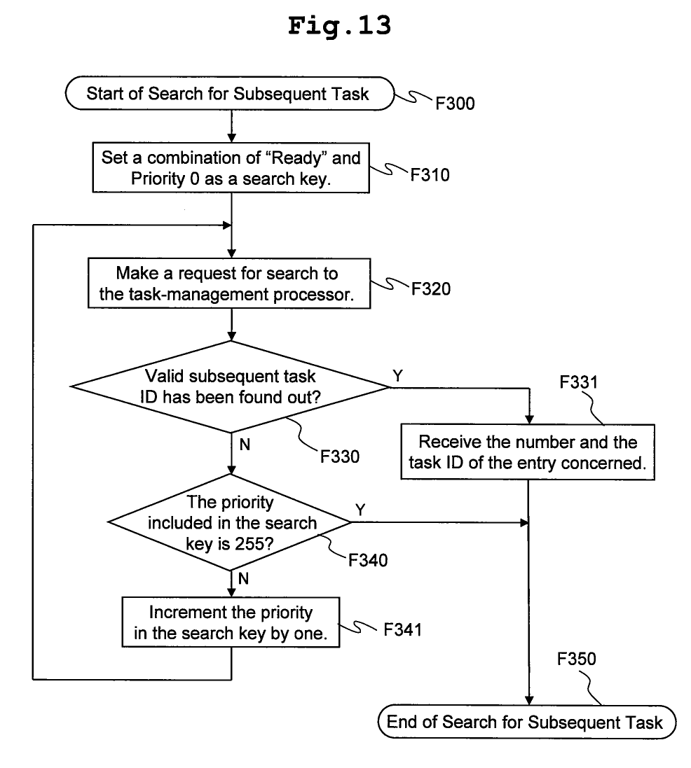

Of these actions, the details of the search for a subsequent task (Step F155) is as exemplified in FIG. 13. First, onto the search-key field 318-2 set is a search key expressing a prospective task which would be run subsequently, e.g. a combination of “Valid” for the enable field, “Ready” for the task-state field, and “0 (top priority)” for the run-priority field (Step F310). On writing onto the search-request field 318-1, it is requested to search the task-state-management array 330 (Step F320). In the case where the content of the search-result-validity field 318-3 shows that the result of search is valid, and valid information on a subsequent task fitting the search key is found (Step F330), contents of the task-ID field 318-4 and entry-position field 318-5 are received as a task ID and an entry number for a task to be run subsequently (Step F331). When no valid subsequent task has been found, the run priority in the search key is incremented up to 255 (the lowest priority) in order, and the search request is repeated (Steps F340 and F341).

Herein, the task-management processor 300 responds to a request for search the task-state-management array 330 (Step F320), and makes a search with a search key. The 340 receives a result of comparison, identifies an entry having the highest entry priority based on the comparison result, and supplies this result to the task ID table 360. In short, it is easy to uniquely ensure the time sequence of entries in the side of the task-management processor 300, and therefore a given task ID can be identified from CAM search results by factoring in the priorities adhering to the time sequence. Thus, priority control of task selection factoring in the time sequence can be performed readily at a high speed.

In regard to the increment of the run priorities and a re-search request, a method that the main processor carries out the processes throughout all run priorities as described above, otherwise only the run priorities within a predetermined range are targeted for the search, or a method that the re-search is automatically executed in the task-management processor 300 independently of the main processor 200 may be adopted. As a result, it becomes possible to materialize multitask control with flexibility and high-level real-time characteristic, in which the time required for the search and the processing load on the main processor 200 are reduced.

Next, the flow of array alignment control in the task-management processor will be described with reference to FIGS. 14 and 15. The array alignment refers to a process of eliminating the discontinuity of valid entries by shifting an entry neighboring a task-state-management entry of the task-state-management array constituting FIFO, from which at the time of the completion of a running task, the information concerning the task is deleted. This makes it easier to ensure the time sequence in the task-state-management array, and enables uniquely deciding an entry, to which a task is to be added subsequently because of consecutive valid entries, whereby multitask control can be simplified and the processing time required for switching a task can be reduced.

When the task-management processor 300 is activated, a search key which includes the content of the search-key field 318-2 is normally output as the task-state-management-array search signal 313 (Step F410), and the working status of the task-management processor is set to the “non-busy” condition (Step F411). After that, on receipt of a search request from the main processor through the search-request field 318-1, the task-management processor executes a search process, and updates the contents of the search-result-validity field 318-3, the task-ID field 318-4 and the entry-position field 318-5 based on the search result (Step F440).

On receipt of an external array update control signal 381 from a neighboring task-management processor (Step F420), the array update control unit 350 updates the working status of the processor into “busy” condition (Step F421), and outputs a signal depending on the content of the update control signal as the array update control signal 352. On receipt of this signal, the array-access-arbitration unit 320 makes a request to the task-state-management array 330 for a shift action on a task-state-management entry targeted for shift through ENTRY-SHIFT ENABLE, and then the shift processing is executed (Step F422). Also, the content of the task ID table 360 is updated so as not to be inconsistent with the content of the task-state-management array 330, in response to the array update control signal 352. The detail of the shift action as described above is notified to the neighboring processor through the external array update control signal 351 (Step F423), whereby the shift action is executed in all the task-management processors connected in the data processing apparatus without inconsistency. When the shift action is completed, the working status of the processors is updated into “non-busy” condition, and each processor monitors the input of a subsequent request for processing.

When the time sequence of entries cannot be ensured because of a malfunction caused by a bug of a CPU task management program, noise, etc., the main processor issues a request for array alignment. On receipt of a request for array alignment from the main processor through the task-state-management-array-update-request field 318-6 (Step F430), the task-management processor executes an array-update process to be described below in detail (Step F431). As exemplified in FIG. 15, in order to search for an unoccupied entry first, a special search key that the enable field is “invalid” and both the task-state field and run-priority field are “comparison mask” is output as a task-state-management-array search signal 313 (Step F510), and the working status of the task-management processor 300 is updated into “busy” condition. Subsequently, the content of the number-of-shifts counter CNT in the array update control unit 350 is initialized into zero (Step F512), and of unoccupied entries, a search for an unoccupied entry assigned the highest priority, i.e. an unoccupied entry with the smallest entry number is made (Step F513). When such unoccupied entry is found (Step F520), the task-state-management entries having entry numbers larger than that of the entry fit for the requirement are all shifted (Step F521), and the details of the shift action is notified to a neighboring processor (Step F522). When “FULL” is specified in the task-state-management-array-update-mode field 318-7 (Step F530), the number-of-shifts counter CNT is incremented (Step F531), and the search for an unoccupied entry is thereafter repeated until the count value of the number-of-shifts counter CNT reaches 254, i.e. (the entry number of the task-state-management entries −1) (Step 540). When no unoccupied entry is found, or the shift action is executed 254 times in the “FULL” mode, the working status of the task-management processor 300 is updated into “non-busy” condition (Step F541), and the search key included in the task-state-management-array search signal 313 is reset into a default search key (Step F542), whereby the task-management processor is brought to the condition where it can receive a subsequent processing request.

The number of tasks which are completed or suspended by the task management program at a time is one at the utmost. As long as the rules concerning the order of using the task-state-management entries are observed, the faulty alignment state of the task-state-management array can be eliminated by one shift action between entries. To avoid a possible defect involved in the task management program and to increase the reliability of the data processing apparatus, “FULL” shift may be executed regularly.

While the invention made by the inventor has been specifically described above based on the embodiments, it is not so limited. It is needless to say that various modifications and changes may be made without departing from the subject matter hereof.

For example, the main processor 200 and the task-management processor 330 are not necessarily limited to being mounted on the same chip. The array 330 and table 360 may be arranged in the same array or separate ones.

### INDUSTRIAL APPLICABILITY

The invention is not limited to the case where it is applied to task control, and it can be applied widely to management of other data which must be managed in consideration of a real-time characteristic.

1. A data processing apparatus comprising:
a memory element array having a plurality of entries each formed by a memory element of more than one bit having a data shift function and a data comparison function, the memory element array being arranged so that data can be shifted between corresponding bit positions of adjacent entries; and
a priority-judging circuit for identifying one of the plurality of entries according to predetermined priorities based on results of comparison between data input to the plurality of entries in common and contents held by memory elements constituting the plurality of entries.

2. The data processing apparatus according to claim 1,
wherein the predetermined priorities are ordinal positions of the entries holding significant data depending on a time sequence when the data were held by the entries.

3. A data processing apparatus comprising:
a memory element array having a plurality of entries each formed by a memory element of more than one bit having a data shift function and a data comparison function, the memory element array being arranged so that data can be shifted in a direction between corresponding bit positions of adjacent entries;
a control circuit which controls a time-based ordinal position of the entry involved in holding of new data toward a direction opposite to a direction of the entry arrayed at the time of data shift in response to an operation command to hold the new data in the entry, and shifts data of the entry upstream to the nullified entries in time sequence toward a downstream direction by the number of the nullified entries in response to an operation command to nullify data held by the entry; and
a priority-judging circuit for identifying one of the plurality of entries according to predetermined priorities based on results of comparison between search data input to the plurality of entries in common and search-target data held by memory elements constituting the plurality of entries,
wherein the predetermined priorities are predetermined ordinal positions in the time sequence.

4. The data processing apparatus according to claim 3, further comprising:
an unoccupied-entry-position pointer for pointing a position of the entry accommodating new data.

5. The data processing apparatus according to claim 4, comprising:
a data table having a plurality of table entries each formed by a memory element of more than one bit having a data shift function, the data table being arranged so that data can be shifted in a direction between corresponding bit positions of adjacent table entries, and the plurality of table entries being in a one-to-one correspondence with the plurality of entries of the memory element array,
wherein the entry of the data table is subjected to data shift in synchronization with data shift performed on the entry of the memory element array, and
the data table outputs data held by the table entry corresponding to the one entry identified by the priority-judging circuit.

6. The data processing apparatus according to claim 5, further comprising:
an expansion-output interface capable of outputting a result of comparison with search-target data in the memory element array; and
an expansion-input interface capable of accepting, as an input, a result of comparison in a preceding stage,
wherein a logical product of the preceding-stage comparison result by the comparison result in the memory element array is produced.

7. A data processing apparatus comprising:
a processor unit capable of running a multitask control program;
a plurality of operation units each assigned with a task to be run by the multitask control program; and
a task-management unit which performs a process of selecting a task to be run by each operation unit,
wherein the task-management unit having
a memory element array having a plurality of entries each formed by a memory element of more than one bit having a data shift function and a data comparison function, the memory element array being arranged so that data can be shifted in a direction between corresponding bit positions of adjacent entries,
a control circuit which controls a time-based ordinal position of the entry involved in holding of new task-management information toward a direction opposite to a direction of the entry arrayed at the time of data shift, in response to an operation command to hold the new task-management information in the entry, and shifts data of the entry upstream to the nullified entries in time sequence toward a downstream direction by the number of the nullified entries in response to an operation command to nullify data held by the entry from the processor unit; and
a priority-judging circuit for identifying one of the plurality of entries according to predetermined priorities based on results of comparison between search data input to the plurality of entries in common and search-target data held by memory elements constituting the plurality of entries, and
the predetermined priorities are predetermined ordinal positions in the time sequence.

8. The data processing apparatus according to claim 7,
wherein the task-management unit outputs a task ID contained in the task management information held by the entry identified by the priority-judging circuit to the processor unit.

9. The data processing apparatus according to claim 8,
wherein the task-management unit has a data table having a plurality of table entries each formed by a memory element of more than one bit having a data shift function, the data table being arranged so that data can be shifted in a direction between corresponding bit positions of adjacent table entries, and the plurality of table entries being in a one-to-one correspondence with the plurality of entries of the memory element array,
wherein the entry of the data table is subjected to data shift in synchronization with data shift performed on the entry of the memory element array, and
the data table outputs the task ID from the table entry corresponding to the one entry identified by the priority-judging circuit.

10. The data processing apparatus according to claim 9,
wherein the task-management unit has an unoccupied-entry-position pointer for pointing the position of an entry which can hold new data.

11. The data processing apparatus according to claim 10, further comprising:
an expansion-output interface capable of outputting a result of comparison with search-target data in the memory element array; and
an expansion-input interface capable of accepting, as an input, a result of comparison in a preceding stage,
wherein a logical product of the preceding-stage comparison result by the comparison result in the memory element array is produced.

12. The data processing apparatus according to claim 1,
wherein the data processing apparatus is formed on a semiconductor substrate.
